(19) United States
(12) Patent Application Publication
(10) Pub. No.: US 2005/0007901 A1
(43) Pub. Date: Jan. 13, 2005

(54) Optical disc apparatus

(75) Inventor: Sadayuki Takaba, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 10/876,721

(22) Filed: Jun. 28, 2004

(30) Foreign Application Priority Data
Jun. 20, 2003 (JP) P2003-187620

(51) Int. Cl. G11B 7/00

(52) U.S. Cl. 369/44.27; 369/44.29; 369/44.35

(57) ABSTRACT

In an optical disc apparatus, when a lens of a pickup head is moved from a predetermined point A to point B and a base point of a focus pull-in range is detected, a point D, which is an initial position of the lens, is set on the basis of the detected base point of the focus pull-in range. This initial position is set between the point A and the point B. The lens is then moved from the point B to the point D which is the initial position, and after that, the lens is moved toward the focus pull-in range, and when a focus error signal is obtained, a focus servo is turned ON.

### BACKGROUND OF THE INVENTION

1. Field of the Invention

This invention relates to an optical disc apparatus which reads and reproduces data recorded on an optical disc such as CD and DVD.

2. Description of the Related Art

Conventionally, an optical disc apparatus, which reads data recorded on an optical disc such as CD, DVD, as well known, irradiates laser light on a data recording surface of an optical disc set on a main body, and detects reflected light thereof by a light receiving device (PD), and thereby, reads data which has been recorded on this optical disc. The optical disc apparatus uses a 4-split light receiving device in which a light receiving area is split vertically and horizontally, and obtains a focus error signal (hereinafter, referred to as FE signal) which shows deviation of a focus position of laser light irradiated on an optical disc and a data recording surface of the optical disc, a tracking error signal (hereinafter, referred to as TE signal) which shows deviation of an irradiation position of the laser light and a track of the optical disc, and a reading signal (hereinafter, referred to as RF signal) of data which has been recorded on the optical disc. The optical disc apparatus turns ON such a focus servo that a lens is moved in such a direction that it approaches to and comes apart from the optical disc on the basis of the FE signal, to have the focus position of laser light coincided with the data recording surface of the optical disc, and such a tracking servo that the lens is moved in a radius direction of the optical disc on the basis of the TE signal to have the irradiation position of the laser light coincided with a center of a track of the optical disc, and reads the data which has been recorded on the optical disc.

As is known, a light emitting device (LD), the lens, and the light receiving device (PD) are disposed on a pickup head.

The optical disc apparatus, when it starts reading of the data recorded on an optical disc set on a main body, moves a lens from a predetermined first position to a second position, and detects a position (range) of a lens in which the FE signal is obtained, as a focus pull-in range. The focus pull-in range is several μm (approximately 6 μm), and a moving range of the lens from the first position to the second position is approximately 1.5 mm. In a general optical disc apparatus, on the occasion of detecting the above-described focus pull-in range, it moves a lens in a direction of approaching to an optical disc. In other words, the above-described first position is a position which comes away from an optical disc, more than the second position.

The optical disc apparatus, when it detects the focus pull-in range by the above-described process, moves the lens from the second position to the first position (returns a position of the lens to the first position). And, it moves the lens again in a direction of the second position (detected focus pull-in range), and when a position of the lens is in the focus pull-in range detected in advance, and the FE signal is obtained, it turns ON the focus servo. After that, it turns on the tracking servo, and starts reading of data recorded on an optical disc.

In the meantime, as disclosed in JP-A-11-120570 and JP-A-6-290466, it is desired to shorten time which is required until the focus servo is turned ON. To this request, if a moving speed of the lens at the time of detecting the focus pull-in range and at such a time point that the focus servo is turned ON is simply fast, heightened is such a possibility that the focus pull-in range cannot be detected, and when the focus servo is turned ON, pulling-in of a focus is failed, so that reliability of an apparatus main body is lowered. In other words, with regard to a moving speed of the lens at the time of detecting the focus pull-in range and at such a time point that the focus servo is turned ON, it is not possible to make it so fast.

In this connection, in JP-A-11-120570, proposed is to carry out processing until the focus servo is turned ON by speeding up a movement of a lens, only in case that a focus is disengaged after access. Also, in JP-A-6-290466, proposed is to speed up a moving speed of a lens when the focus pull-in range is detected, and to slow down the moving speed of the lens when the focus servo is turned ON.

### SUMMARY OF THE INVENTION

However, in JP-A-11-120570, it is possible to shorten time until the focus servo is turned ON again, in case that a focus is disengaged after access, but it is impossible to shorten time until the focus servo is turned ON before access, at such time that an optical disc is set in a main body, and so on.

Also, in JP-A-6-290466, since it is configured to speed up a moving speed of a lens when the focus pull-in range is detected, there is a high possibility that detection of the focus pull-in range is failed, and there is such a case that detection of the focus pull-in range is failed again and again continuously, and as a result, time which is required until the focus servo is turned ON is lengthened.

An objective of this invention is to provide an optical disc apparatus which can shorten time which is required until the focus servo is turned ON, including detection of the focus pull-in range.

An optical disc apparatus of this invention is equipped with the following configuration in order to accomplish the above-described objective.

(1) An optical disc apparatus including:
a pickup head which irradiates laser light to a data recording surface of an optical disc set on a main body through a lens, and which detects reflected light thereof; and
focus control means which turns ON and OFF a focus servo in which a focus error signal that shows deviation of a focus position of the laser light to the data recording surface of the optical disc from the reflected light detected by the pickup head is obtained, and the lens of the pickup head is shifted on the basis of this focus error signal to have a focus position of the laser light coincide with the data recording surface of the optical disc;
wherein data recorded on the optical disc is reproduced from the reflected light detected by the pick up head;
wherein the optical disc apparatus further comprises:
   focus pull-in range detecting means which moves the lens of the pickup head from a predetermined first position to a second position, and which detects a moving range of the lens as a focus pull-in range in which the focus error signal is obtained; and
   initial position setup means which sets up an initial position of the lens, between the first position and the second position on the basis of the focus pull-in range detected by the focus pull-in range detecting means; and
wherein the focus control means moves the lens to the initial position set up by the initial position setup means, and then moves the lens toward the focus pull-in range, and when the focus error signal is obtained, turns ON the focus servo.

In this configuration, when the focus pull-in range is detected by moving the lens of the pickup head from the predetermined first position to the second position, the initial position of the lens is set on the basis of the detected focus pull-in range. This initial position is set up between the first position and the second position, and then, the lens is moved from the second position to the initial position, and after that, the lens is moved toward the focus pull-in range, and when the focus error signal is obtained, the focus servo is turned ON.

In this manner, since it is configured in such a manner that the lens is moved to the initial position of the lens set on the basis of the detected focus pull-in range, but not in such a manner that the lens is moved from the second position to the first position after the focus pull-in range is detected, it is possible to shorten a total moving amount of lens moving, during a period until the focus servo is turned ON. By this, realized is shortening of time which is required for a movement of a lens. Therefore, it is possible to shorten time which is required until the focus servo is turned ON.

Also, a direction of the first position to the second position is, in a general optical disc apparatus, such a direction that a lens approaches to an optical disc, but it may be an opposite direction.

Also, the focus control means makes a moving speed when it moves the lens to the initial position set by the initial position setup means faster than a moving speed of the lens from the first position to the second position by the focus pull-in range detecting means, and thereby, realized is shortening of time which is required for moving the lens to the initial position, and therefore, it is possible to more shorten time which is required until the focus servo is turned ON.

(2) An optical disc apparatus including:
a pickup head which irradiates laser light to a data recording surface of an optical disc set on a main body through a lens, and which detects reflected light thereof; and
focus control means which turns ON and OFF a focus servo in which a focus error signal that shows deviation of a focus position of the laser light to the data recording surface of the optical disc from the reflected light detected by the pickup head is obtained, and the lens of the pickup head is shifted on the basis of this focus error signal to have a focus position of the laser light coincide with the data recording surface of the optical disc;
wherein data recorded on the optical disc is reproduced from the reflected light detected by the pick up head;
wherein the optical disc apparatus further comprises focus pull-in range detecting means which moves the lens of the pickup head from a predetermined first position to a second position, and which detects a moving range of the lens as a focus pull-in range in which the focus error signal is obtained; and
wherein the focus control means moves the lens to the first position faster than a moving speed of the lens from the first position to the second position by the focus pull-in range detecting means, and then moves the lens toward the focus pull-in range, and when the focus error signal is obtained, turns ON the focus servo.

In this configuration, when the focus pull-in range is detected by moving the lens of the pickup head from the predetermined first position to the second position, the lens is moved from the second position to the first position at high speed, and after that, the lens is moved toward the focus pull-in range, and when the focus error signal is obtained, the focus servo is turned ON.

Therefore, realized is shortening of time which is required for moving the lens to the first position, after the focus pull-in range was detected, and therefore, it is possible to shorten time which is required until the focus servo is turned ON.

### BRIEF DESCRIPTION OF THE DRAWINGS

FIG. 1 is a view showing a configuration of a major part of an optical disc apparatus according to an embodiment of this invention;

FIGS. 2A and 2B are views showing a configuration of a pickup head;

FIG. 3 is a flow chart showing an operation which relates to focus ON of the optical disc apparatus;

FIGS. 4A and 4B are diagrams showing positional changes of a lens in an operation which relates to the focus ON of the optical disc apparatus;

FIGS. 5A and 5B are diagrams showing a focus error signal and an RF signal;

FIG. 6 is a diagram showing positional changes of a lens in an operation which relates to the focus ON of an optical disc apparatus of another embodiment of the invention; and

FIG. 7 is a diagram showing positional changes of a lens in an operation which relates to the focus ON of an optical disc apparatus of still another embodiment of the invention.

### DETAILED DESCRIPTION OF THE PREFFERED EMBODIMENTS

Hereinafter, an optical disc apparatus according to an embodiment of this invention will be described.

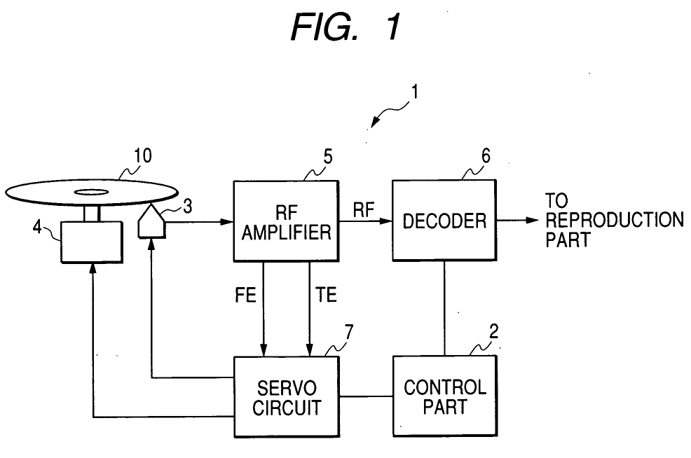

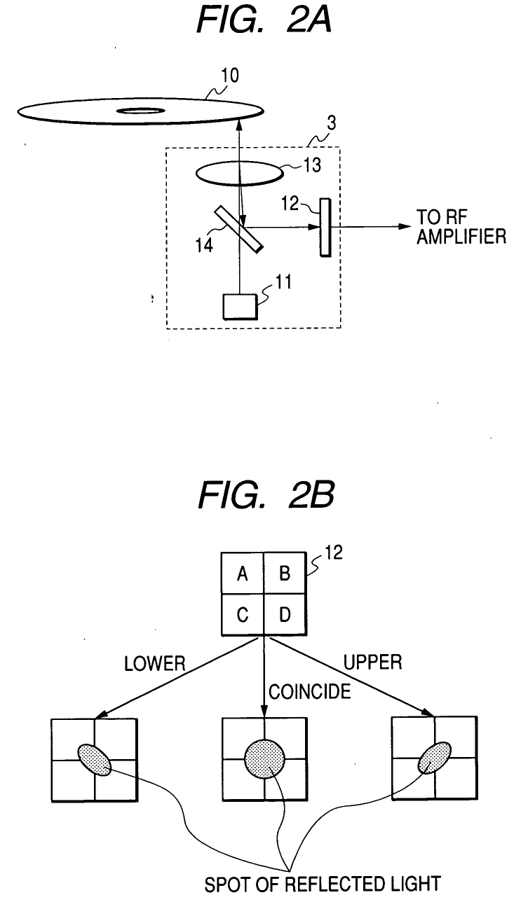

FIG. 1 is a view which shows a configuration of a major part of the optical disc apparatus according to an embodiment of this invention, in particular, a configuration which relates to reading of data. In the figure, 1 designates an optical disc apparatus main body, and 2 designates a control part which controls an operation of the main body. 3 designates a pickup head, and as shown in FIG. 2A, is equipped with a laser diode 11 (hereinafter, referred to as LD11) which irradiates laser light to an optical disc 10, a light receiving device 12 (hereinafter, referred to as PD12) which detects reflected light from the optical disc 10, a lens 13 for taking the focus on a data recording surface of the optical disc 10, and a beam splitter 14 which guides the reflected light from the optical disc 10 to the PD12. The lens 13 is held movably in such a direction that it approaches to and comes apart from the optical disc 10, and in a radius direction of the optical disc 10. The PD12 is of such a 4-split type as shown in FIG. 2B that a light receiving area is split vertically and horizontally. When a focus position of laser light, which is irradiated on the optical disc 10, is lower than the data recording surface of the optical disc 10, when it coincides with the data recording surface of the optical disc 10, and when it is upper than the data recording surface of the optical disc 10, a shape of a spot of the reflected light which is received by the PD12 changes as shown in FIG. 2B.

Returning to FIG. 1, 4 designates a spindle motor which relates the optical disc 10. 5 designates a RF amplifier which amplifies an output of the PD12, and outputs a focus error signal (hereinafter, referred to as FE signal), a tracking error signal (hereinafter, referred to as TE signal), and a reading signal (hereinafter, referred to as RF signal) of data which has been recorded on a optical disc. The FE signal is, as well known, a differential signal of an amount of the reflected light which was received by light receiving areas A, D of the PD12, and an amount of the reflected light which was received by light receiving areas B, C (FE signal=(A+D)−(B+C)). Also, the TE signal is, as well known, a differential signal of an amount of the reflected light which was received by light receiving areas A, C of the PD12, and an amount of the reflected light which was received by light receiving areas B, D (TE signal=(A+C)−(B+D)). The RF signal is a summation signal of an amount of the reflected light which was received by the light receiving areas A, B, C, D (RF signal=A+B+C+C).

In addition, the FE signal, the TE signal, and the RF signal which are outputted from the RF amplifier 5 are such signals that an output of the PD12 was amplified.

6 designates a data recorder to which the RF signal is inputted from the RF amplifier 5. The decoder 6 binarizes the inputted RF signal, and decodes this and inputs it to a not-shown reproduction part. 7 designates a servo circuit which carries out the focus servo on the basis of the FE signal, and carries out the tracking servo on the basis of the TE signal. The focus servo means, as well known, control for moving the lens 13 in such a direction that it approaches to and comes apart from the optical disc 10, so as for the focus position of the laser light which is irradiated on the optical disc 10 to coincide with the data recording surface of the optical disc 10. Also, the tracking servo means, as well known, control for moving the lens in a radius direction of the optical disc 10, so as for the irradiation position of the laser light which is irradiated on the optical disc 10 to become a center of a track of the optical disc 10. Also, the servo circuit 7 carries out rotation control of the spindle motor 4, in other words, rotation control of the optical disc 10, and control for moving the pickup head 3 in a radius direction of the optical disc 10 by a not-shown sled mechanism.

Hereinafter, an operation of the optical disc apparatus according to the embodiment of this invention will be described.

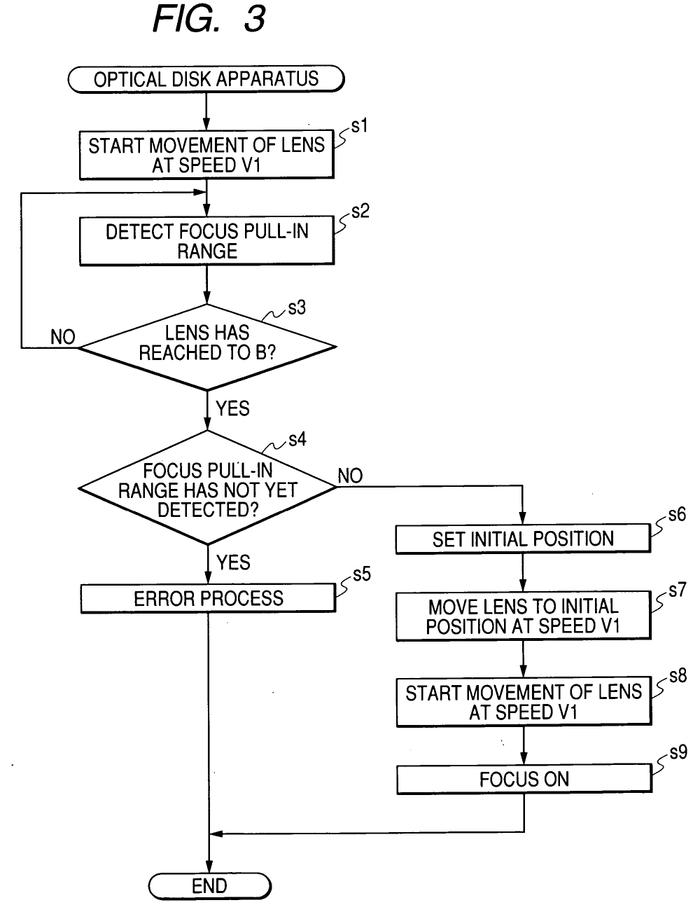

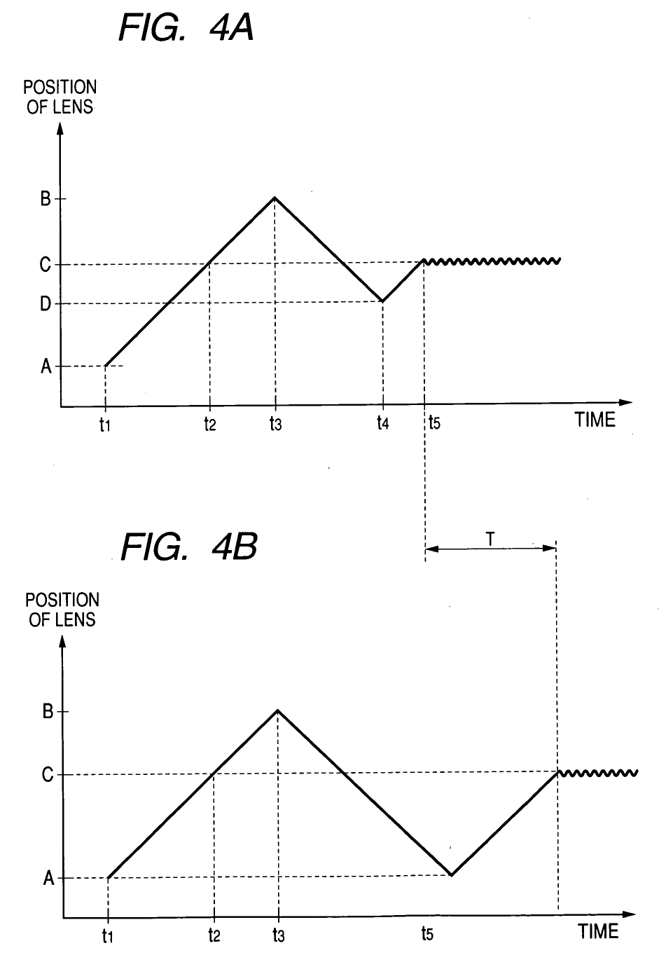

FIG. 3 is a flow chart showing an operation which relates to focus ON of the optical disc apparatus according to the embodiment of this invention. Also, FIG. 4A is a diagram showing changes of a lens position in this operation, and FIG. 4B shows a case of a conventional optical disc apparatus for the sake of comparison. In FIGS. 4A and 4B, a vertical axis designates a position of the lens 13, and a horizontal axis designates time. This operation which relates to the focus ON is carried out when the optical disc 10 is set on the main body, when the focus is disengaged during a period of reproduction, and so on.

A moving range of the lens is point A to point B shown in FIG. 4A. Here, the point A is a position which is apart from the optical disc 10, more than the point B. The point A corresponds to a first position, and the point B corresponds to a second point. The optical disc apparatus 1 moves the lens 13 to the point A. The optical disc apparatus 1 starts a movement of the lens 13 from the point A to the point B, in order to detect the focus pull-in range (s1) (t1 shown in FIG. 4). At this time, a moving speed of the lens 13 is a speed V1 at which it is possible to detect the focus pull-in range almost surely.

The optical disc apparatus 1, after a movement of the lens 13 was started in s1 and until the lens 13 reaches to the point B (t3 shown in FIG. 4), detects a position (range) of the lens, at which the RF signal is larger than a predetermined threshold level and the focus error signal is obtained, as the focus pull-in range (s2, s3). The optical disc apparatus 1, when it did not detect this focus pull-in range (s4), judges that it failed the detection of the focus pull-in range, and carries out an error process in s5. This error process may be such a process that, for example, the lens 13 is moved to the point A, and the detection of the focus pull-in range is carried out again.

A distance from the point A to the point B, i.e., the moving range of the lens 13 is approximately 1.5 mm. Also, as well known, when deviation of the focus position of the laser light which is irradiated on the optical disc 10 and the data recording surface of the optical disc 10 is several μm (approximately 6 μm), the FE signal shown in FIG. 5A is obtained. Also, when this FE signal is obtained, the RF signal is larger than the threshold level (see, FIG. 5B).

The optical disc apparatus 1 carries out processes after s6, shown as follows, in case that the focus pull-in range was detected. Also, the optical disc apparatus 1 sets a position of the lens 13 when the focus pull-in range was detected and when a zero cross of the focus error signal was detected, as a base point of the focus pull-in range.

Incidentally, the base point of the focus pull-in range which is mentioned here does not mean a center of the focus pull-in range which was actually detected.

As shown in FIGS. 4A and 4B, the processes up to here are the same as in the conventional optical disc apparatus, and therefore, the same time is spent. Here, an explanation will be made on such an assumption that a position of the lens 13, which was detected as the base point of the focus pull-in range, is a point C shown in FIGS. 4A and 4B.

The optical disc apparatus 1 sets up an initial position of the lens 13, on the basis of the base point of the focus pull-in range which was detected in advance (s6). The initial position of the lens 13 is set between the point A and the point B. For example, a position, which is apart from the base point of the focus pull-in range by a predetermined amount, e.g., 0.2 to 0.3 mm, is set as the initial position. The optical disc apparatus 1 moves the lens 13 from the point B to a point D which is the initial position set in s6 (s7). A moving speed of the lens 13 at this time is also V1.

The optical disc apparatus 1, when it moves the lens 13 to the point D which is the initial position (t4 shown in FIG. 4A), starts a movement of the lens 13 toward the focus pull-in range which was detected in advance (s8), and when the FE signal is obtained in the vicinity of the focus pull-in range which was detected in advance, turns ON the focus servo (s9) (t5 shown in FIG. 4A).

After this, it turns ON the tracking servo, and starts reading of data such as TOC which has been recorded on the optical disc 10. Since a process for turning ON the tracking servo, a process for reading data such as TOC which has been recorded on the optical disc 10 are well known, explanations thereof will be omitted here.

In this manner, the optical disc apparatus 1 of this embodiment is configured in such a manner that the initial position (point D) of the lens 13 is set on the basis of the detected focus pull-in range, and the focus servo is turned ON by moving the lens 13 to the point D which is the initial position set, and by moving the lens 13 from this point D toward the focus pull-in range, but not by moving the lens 13 from the point B to the point A after the focus pull-in range was detected, it is possible to suppress a total moving amount of the lens 13 in this series of processes. Therefore, as shown in FIGS. 4A and 4B, it is possible to shorten time which is required until the focus servo is turned ON, by time T, as compared with the conventional optical disc apparatus.

In addition, the conventional optical disc apparatus is, as shown in FIG. 4B of such a configuration that, after the lens 13 was moved from the point B to the point A, the lens 13 is moved from the point A toward the focus pull-in range, and then, the focus servo is turned ON.

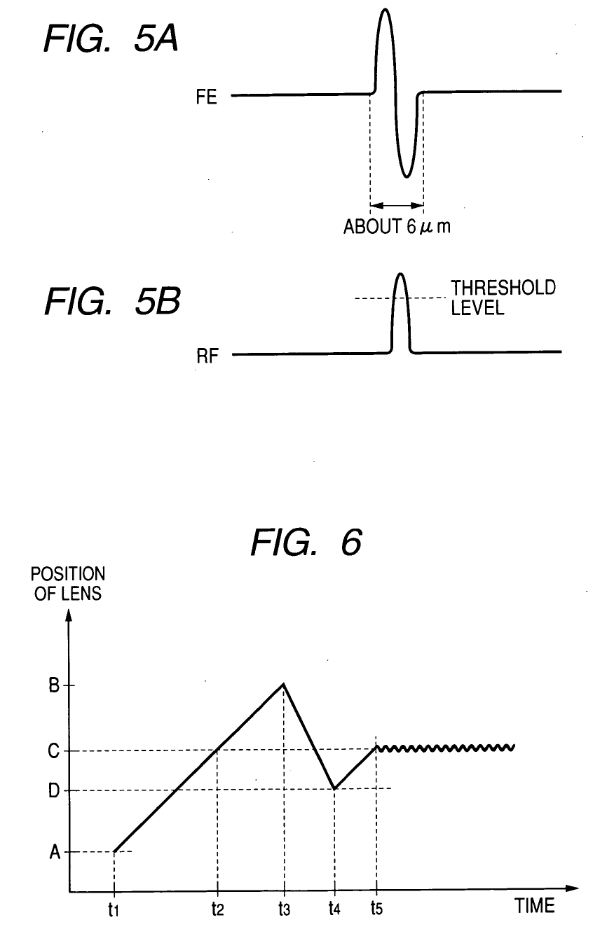

Also, in the above-described embodiment, it is configured that a moving speed of the lens 13 from the point A to the point B on the occasion of detecting the focus pull-in range, a moving speed of the lens 13 from the point B to the point D which is the initial position after the detection of the focus pull-in range was completed, and a moving speed of the lens 13 from the point D to the focus pull-in range, are all the same speed, but as shown in FIG. 6, the moving speed of the lens 13 from the point B to the point D which is the initial position after the detection of the focus pull-in range was completed may be made faster. If this is realized, it is possible to more shorten time which is required until the focus serve is turned ON.

In addition, during this period of time, the lens 13 is simply moved from the point B to the point D, and therefore, even if the moving speed of the lens 13 is made faster, there occurs no problem at all.

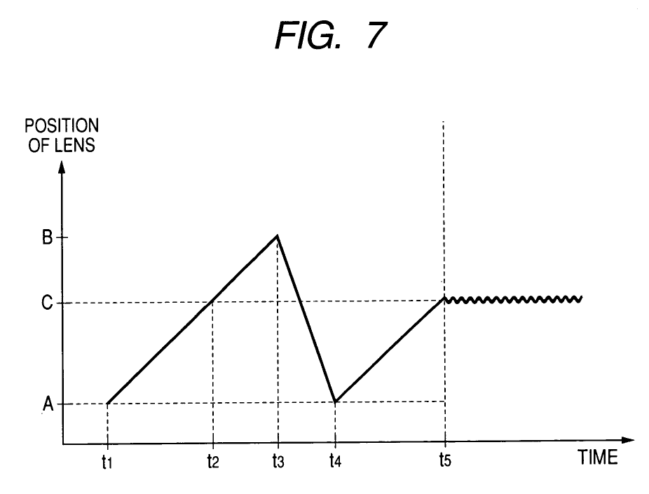

Furthermore, in the above-described embodiments, the initial position of the lens 13 is set on the basis of the detected focus pull-in range, but without setting this initial position, alternatively, the moving speed of the lens 13 from the point B to the point A after the detection of the focus pull-in range was completed may be made faster (see, FIG. 7). Even in case of this, realized is shortening of time which is required until the focus servo is turned ON.

In addition, in the above-described embodiments, the point A is a position which is apart from the optical disc 10, more than the point B, but the point B may be a position which is apart from the optical disc 10, more than the point A. In other words, a moving direction of the lens 13 in the above-described explanations may be reversed.

Also, even at the time of writing data to the optical disc, by turning ON the focus servo by the above-described method, it is possible to shorten time which is required until the focus servo is turned ON.

As was described above, according to this invention, since it is possible to suppress a total moving amount of a lens until a focus servo is turned ON, realized is shortening of time which is required until the focus servo is turned ON.

Also, since a lens is moved to a first position at high speed, after a focus pull-in range was detected, it is possible to shorten time which is required until the focus servo is turned ON.

1. An optical disc apparatus comprising:
a pickup head which irradiates laser light to a data recording surface of an optical disc set on a main body through a lens, and which detects reflected light thereof; and
focus control means which turns ON and OFF a focus servo in which a focus error signal that shows deviation of a focus position of the laser light to the data recording surface of the optical disc from the reflected light detected by the pickup head is obtained, and the lens of the pickup head is shifted on the basis of this focus error signal to have a focus position of the laser light coincide with the data recording surface of the optical disc;
wherein data recorded on the optical disc is reproduced from the reflected light detected by the pick up head;
wherein the optical disc apparatus further comprises;
focus pull-in range detecting means which moves the lens of the pickup head from a predetermined first position to a second position, and which detects a moving range of the lens as a focus pull-in range in which the focus error signal is obtained; and
initial position setup means which sets up an initial position of the lens, between the first position and the second position on the basis of the focus pull-in range detected by the focus pull-in range detecting means;
wherein a direction from the first position to the second position is such a direction that the lens approaches to the optical disc; and
wherein the focus control means moves the lens to the initial position set up by the initial position setup means, faster than a moving speed of the lens from the first position to the second position by the focus pull-in range detecting means, and then moves the lens toward the focus pull-in range, and when the focus error signal is obtained, turns ON the focus servo.

2. An optical disc apparatus comprising:
a pickup head which irradiates laser light to a data recording surface of an optical disc set on a main body through a lens, and which detects reflected light thereof; and
focus control means which turns ON and OFF a focus servo in which a focus error signal that shows deviation of a focus position of the laser light to the data recording surface of the optical disc from the reflected light detected by the pickup head is obtained, and the lens of the pickup head is shifted on the basis of this focus error signal to have a focus position of the laser light coincide with the data recording surface of the optical disc;
wherein data recorded on the optical disc is reproduced from the reflected light detected by the pick up head;
wherein the optical disc apparatus further comprises:
focus pull-in range detecting means which moves the lens of the pickup head from a predetermined first position to a second position, and which detects a moving range of the lens as a focus pull-in range in which the focus error signal is obtained; and
initial position setup means which sets up an initial position of the lens, between the first position and the second position on the basis of the focus pull-in range detected by the focus pull-in range detecting means; and
wherein the focus control means moves the lens to the initial position set up by the initial position setup means, and then moves the lens toward the focus pull-in range, and when the focus error signal is obtained, turns ON the focus servo.

3. The optical disc apparatus as set forth in claim 2, wherein a direction from the first position to the second position is such a direction that the lens approaches to the optical disc.

4. The optical disc apparatus as set forth in claim 2, wherein the focus control means makes a moving speed when it moves the lens to the initial position which by the initial position setup means faster than a moving speed of the lens from the first position to the second position by the focus pull-in range detecting means.

5. An optical disc apparatus comprising:
a pickup head which irradiates laser light to a data recording surface of an optical disc set on a main body through a lens, and which detects reflected light thereof; and
focus control means which turns ON and OFF a focus servo in which a focus error signal that shows deviation of a focus position of the laser light to the data recording surface of the optical disc from the reflected light detected by the pickup head is obtained, and the lens of the pickup head is shifted on the basis of this focus error signal to have a focus position of the laser light coincide with the data recording surface of the optical disc;
wherein data recorded on the optical disc is reproduced from the reflected light detected by the pick up head;
wherein the optical disc apparatus further comprises focus pull-in range detecting means which moves the lens of the pickup head from a predetermined first position to a second position, and which detects a moving range of the lens as a focus pull-in range in which the focus error signal is obtained; and
wherein the focus control means moves the lens to the first position faster than a moving speed of the lens from the first position to the second position by the focus pull-in range detecting means, and then moves the lens toward the focus pull-in range, and when the focus error signal is obtained, turns ON the focus servo.

6. An optical disc apparatus comprising;
a pickup head which irradiates laser light to a data recording surface of an optical disc set on a main body through a lens, and which detects reflected light thereof;
a focus control unit which turns ON and OFF a focus servo in which a focus error signal that shows deviation of a focus position of the laser light to the data recording surface of the optical disc from the reflected light detected by the pickup head is obtained, and the lens of the pickup head is shifted on the basis of this focus error signal to have a focus position of the laser light coincide with the data recording surface of the optical disc;
a focus pull-in range detecting unit which moves the lens of the pickup head from a predetermined first position to a second position, and which detects a moving range of the lens as a focus pull-in range in which the focus error signal is obtained; and
an initial position setup unit which sets up an initial position of the lens, between the first position and the second position on the basis of the focus pull-in range detected by the focus pull-in range detecting unit;
wherein the focus control unit moves the lens to the initial position set up by the initial position setup unit, and then moves the lens toward the focus pull-in range, and when the focus error signal is obtained, turns ON the focus servo.

7. An optical disc apparatus comprising;
a pickup head which irradiates laser light to a data recording surface of an optical disc set on a main body through a lens, and which detects reflected light thereof;
a focus control unit which turns ON and OFF a focus servo in which a focus error signal that shows deviation of a focus position of the laser light to the data recording surface of the optical disc from the reflected light detected by the pickup head is obtained, and the lens of the pickup head is shifted on the basis of this focus error signal to have a focus position of the laser light coincide with the data recording surface of the optical disc; and
a focus pull-in range detecting unit which moves the lens of the pickup head from a predetermined first position to a second position, and which detects a moving range of the lens as a focus pull-in range in which the focus error signal is obtained;
wherein the focus control unit moves the lens to the first position faster than a moving speed of the lens from the first position to the second position by the focus pull-in range detecting unit, and then moves the lens toward the focus pull-in range, and when the focus error signal is obtained, turns ON the focus servo.
